(19) United States
(12) Patent Application Publication
(10) Pub. No.: US 2021/0201294 A1
(43) Pub. Date: Jul. 1, 2021

(54) BANK CARD PRIVACY INFORMATION HIDING METHOD, BANK CARD AND COMPUTER READABLE STORAGE MEDIUM

(71) Applicant: GIESECKE+DEVRIENT MOBILE SECURITY GMBH, Munich (DE)

(72) Inventor: Jie HE, Jiangxi (CN)

(21) Appl. No.: 17/251,948

(22) PCT Filed: Jun. 26, 2019
(86) PCT No.: PCT/CN2019/092927

§ 371 Date: Dec. 14, 2020

(30) Foreign Application Priority Data
Jun. 27, 2018 (CN) 201810677365.6

(51) Int. Cl. G06Q 20/34; G06K 19/073

(52) U.S. Cl. CPC G06Q 20/34; G06K 19/07345

(57) ABSTRACT

The application provides a bank card privacy information hiding method, a bank card and a computer readable storage medium, acquiring verification information of the bank card; if the verification information passes a verification, displaying privacy information of the bank card on a display screen of the bank card. According to the scheme, the privacy information of the bank card is displayed to a user based on verification, so that the privacy information of any user involved in the bank card can be protected, such as the card number, the validity period, the security code and the like on the card surface are displayed on the card surface after verification is passed, thereby ensuring the use safety of the bank card and avoiding user loss.

### TECHNICAL FIELD

The application relates to the field of bank card, in particular to a bank card privacy information hiding method, a bank card and a computer readable storage medium.

### BACKGROUND

Bank card, also called chip bank card, is a financial transaction card with a chip as a medium. The chip card has a large capacity and can store information such as secret keys and digital certificates and so on. Its working principle is similar to that of a microcomputer, and it can handle multiple functions simultaneously, providing convenience for cardholders to use one card for multiple purposes. The bank card is a financial instrument issued by commercial banks (credit cooperatives) or payment institutions, which adopt integrated circuit technology and follow national financial industry standards. They have all or part of the financial functions of consumer credit, transfer and settlement, cash deposit and withdrawal, and can have other commercial services and social management functions.

With the continuous development of communication and Internet technology, there are more and more means of information acquisition. Users often face more or less risks of information leakage, especially financial cards involving user assets. Therefore, in order to avoid user loss, how to effectively ensure the use safety of the bank card has become a main problem we are currently facing.

### SUMMARY

The application provides a bank card privacy information hiding method, a bank card and a computer readable storage medium, which are used for effectively ensuring the use safety of the bank card.

The first aspect of the application is to provide a bank card privacy information hiding method, comprising:

acquiring verification information of a bank card; and
if the verification information passes a verification, displaying privacy information of the bank card on a display screen of the bank card.

Optionally, the acquiring the verification information of the bank card comprises:

receiving verification information input by a user on a surface of the bank card.

Optionally, before the acquiring the verification information of the bank card, the method further comprises:

receiving unlocking information input by the user on the surface of the bank card;
wherein the unlocking information includes at least one of the following information: fingerprint unlocking information, gesture unlocking information and password unlocking information.

Optionally, it further comprises:

receiving the unlocking information input by the user in an unlocking identification area of the bank card; and
if the unlocking information makes successful unlocking, activating a verification operation function for the bank card, and displaying the verification operation function to the user in the display screen of the bank card.

Optionally, the privacy information of the bank card includes at least one of the following information:

identification information of the bank card, identification information of the bank card holder, attribute information of the bank card, a security code of the bank card, credit limit information of the bank card, and consumption information of the bank card.

Optionally, after the acquiring the verification information of the bank card, the method further comprises:

verifying an identity of the holder of the bank card according to the verification information, and if the verification is passed, displaying the privacy information of the bank card on the display screen of the bank card.

A second aspect of the present application is to provide a bank card comprising:

an acquisition module configured to acquire verification information of the bank card; and
a display module configured to display the privacy information of the bank card on a display screen of the bank card when the verification information passes the verification.

Optionally, the acquisition module comprises:

a first receiving sub-module configured to receive verification information input by a user on the surface of the bank card.

Optionally, the acquisition module further comprises:

A second receiving sub-module configured to receive unlocking information input by the user on the surface of the bank card.

The unlocking information includes at least one of the following information:

fingerprint unlocking information, gesture unlocking information and password unlocking information.

Optionally, the second receiving sub-module is specifically configured to receive the unlocking information input by the user in an unlocking identification area of the bank card;

The bank card further comprises:

an activation module configured to activate a verification operation function for the bank card when the unlocking information makes successful unlocking;
wherein the display module is further configured to display the verification operation function to the user in the display screen of the bank card.

Optionally, the privacy information of the bank card includes at least one of the following information:

identification information of the bank card, identification information of the bank card holder, attribute information of the bank card, a security code of the bank card, credit limit information of the bank card, and consumption information of the bank card.

Optionally, it further comprises:

a verification module configured to verify an identity of the holder of the bank card according to the verification information;
wherein the display module is further configured to display the privacy information of the bank card on the display screen of the bank card when the verification module passes the verification.

A third aspect of the application is to provide a bank card comprising: a processor and a memory; the memory storing a computer program; the processor executing the computer program stored in the memory to perform the method as described previously.

A fourth aspect of the present application is to provide a computer readable storage medium having stored therein a computer program that, when executed by a processor, performs the method as described above.

According to the bank card privacy information hiding method, the bank card and the computer readable storage medium provided by the application, verification information of the bank card is acquired; and if the verification information passes the verification, the privacy information of the bank card is displayed on a display screen of the bank card. According to the scheme, the privacy information of the bank card is displayed to the user based on verification, so that the privacy information of any user involved in the bank card can be protected, such as the card number, the validity period, the security code and the like on the card surface are displayed on the card surface after the verification is passed, thereby ensuring the use safety of the bank card and avoiding user loss.

### BRIEF DESCRIPTION OF THE DRAWINGS

The accompanying drawings, which are incorporated in and constitute a part of this specification, illustrate embodiments consistent with this application and together with the description serve to explain the principles of this application.

FIG. 1 is a flowchart of a bank card privacy information hiding method provided by an exemplary embodiment of the application;

FIG. 2 is a flowchart of a bank card privacy information hiding method provided by another exemplary embodiment of the application;

FIG. 3 is a schematic structural diagram of a bank card provided by an exemplary embodiment of the application;

FIG. 4 is a schematic structural diagram of a bank card provided by another exemplary embodiment of the application;

FIG. 5a is a schematic structural diagram of a bank card provided by an exemplary embodiment of the application; and

FIG. 5b is a schematic structural diagram of a bank card provided by an exemplary embodiment of the application.

Specific embodiments of the application have been shown in the above drawings and will be described in more detail hereinafter. The drawings and the written description are not intended to limit the scope of the concept of the application in any way, but to illustrate the concept of the application to those skilled in the art by referring to specific embodiments.

### DETAILED DESCRIPTION

Exemplary embodiments will be described in detail herein, examples of which are shown in the accompanying drawings. When the following description refers to the drawings, unless otherwise indicated, the same numbers in different drawings indicate the same or similar elements. The embodiments described in the following exemplary examples do not represent all embodiments consistent with this application. On the contrary, they are merely examples of apparatuses and methods consistent with some aspects of the present application as detailed in the appended claims. The embodiments in the application can be implemented separately or in combination without conflict.

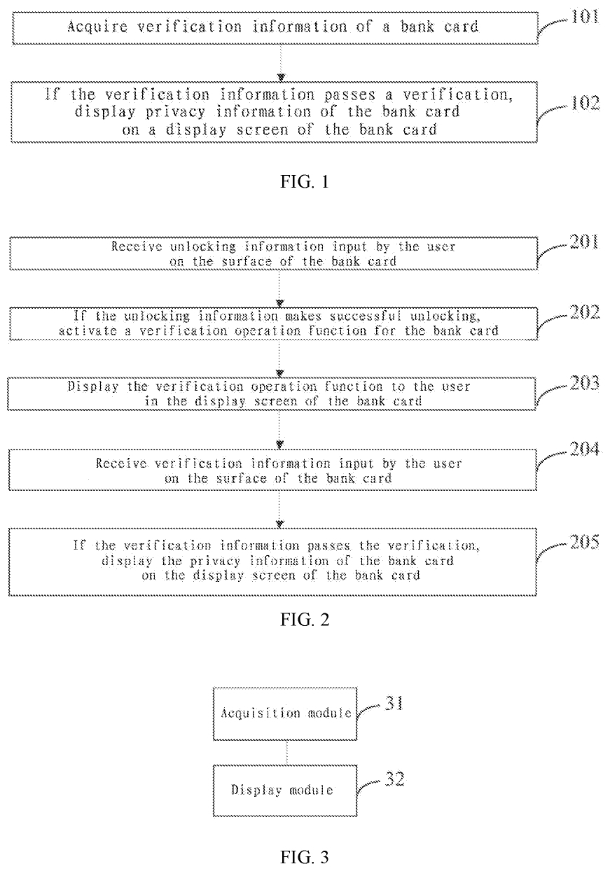

FIG. 1 is a schematic flow chart of a bank card privacy information hiding method provided by an exemplary embodiment of the application. Referring to FIG. 1, the embodiment provides a bank card privacy information hiding method for improving the security of a bank card. Specifically, the embodiment uses the bank card privacy information hiding method applied to a bank card to illustrate the method, which includes:

Step 101: acquiring verification information of a bank card.

Step 102: if the verification information passes a verification, displaying the privacy information of the bank card on a display screen of the bank card.

In practical application, the executing body of this embodiment may be a bank card, which is integrated with a processing chip that has functions of reading and executing computer programs to execute related computer programs, thus implementing the method provided by this scheme. Alternatively, the processing chip may have a China Operating System (COS). The bank card may be integrated with components for implementing user interaction, such as a display screen, an input component, a touch screen and the like. As an example, the display screen may be a flexible display medium, or the display screen may be a touch screen integrated with display and touch functions; the input component can be a button arranged on the card surface of the bank, and the button may include function buttons such as moving up, moving down, moving left, moving right, confirming and the like. The user inputs the verification information of the bank card by operating the buttons, and if the verification information passes the verification, the privacy information associated with the bank card is displayed on the display screen of the bank card. For example, the card face information of the bank card, such as card number, validity period, security code CVV2 code, and the like, is displayed on the display screen. So it is realized that the privacy information of any bank card is not displayed on the card surface of the bank card, and the user inputs verification information by operating the bank card, and the privacy information of the bank card is displayed to the user after the verification is passed, thereby ensuring the use safety of the bank card and avoiding user loss.

According to the bank card privacy information hiding method provided by the embodiment, the verification information of the bank card is acquired; if the verification information passes the verification, the privacy information of the bank card is displayed on the display screen of the bank card. According to the scheme, the privacy information of the bank card is displayed to the user based on verification, so that the privacy information of any user involved in the bank card may be protected, such as the card number, the validity period, the security code and the like on the card surface are displayed on the card surface after verification passes, thereby ensuring the use safety of the bank card and avoiding user loss.

FIG. 2 is a flowchart of a bank card privacy information hiding method provided by another exemplary embodiment of the application. As shown in FIG. 2, on the basis of the above embodiment, the bank card privacy information hiding method of the embodiment includes:

Step 201: receiving unlocking information input by the user on the card surface of the bank.

In this step, the unlocking information includes at least one of the following information: fingerprint unlocking information, gesture unlocking information, and password unlocking information.

As an example, an area dedicated for unlocking may be set on the card surface of the bank card, and accordingly the unlocking information input by the user in an unlocking identification area of the bank card is received.

For example, if a data keyboard is set on the card surface of a bank card as an unlocking identification area, whether the unlocking is successful or not is determined according to a password input by the user; a fingerprint sensing area may also be arranged on the card surface of the bank card as an unlocking identification area, and whether unlocking is successful or not is determined according to fingerprint information input by the user; and it is also possible to set a touch screen on the card surface of the bank card as described above, and use the touch screen as an unlocking recognition area, and then determine whether the unlocking is successful or not after comparing the gesture input by the user with a preset unlocking gesture.

The unlocking operation can enhance the safety protection of bank card information and reduce the risk of information inside the card being stolen after the bank card is stolen.

Step 202: if the unlocking information makes successful unlocking, activating a verification operation function for the bank card.

Step 203: displaying the verification operation function to the user in the display screen of the bank card.

Specifically, if the bank card is successfully unlocked, its verification operation function will be activated. As an example, after activation, the display screen of the bank card will be lit up, displaying verification options for the user to select, such as whether to display the card surface information, whether to display the balance in the card, whether to display the credit limit of the bank card, and the like. The user may select the privacy information of the bank card to be acquired and complete the corresponding identity verification, thus obtaining the above privacy information. Optionally, different verification levels may be set for different privacy information according to different categories and importance of privacy information. For example, to view the card number, ID card information of the user needs to be input as verification information; to view the balance in the card, the ID card information of the user needs to be input, and the verification code information received by the user's mobile terminal also needs to be input as verification information.

Step 204: receiving the verification information input by the user on the surface of the bank card.

Step 205: if the verification information passes the verification, displaying the privacy information of the bank card on the display screen of the bank card.

As an example, the identity of the holder of the bank card may be verified according to the verification information, and if the verification is passed, the privacy information of the bank card is displayed on the display screen of the bank card. The privacy information of the bank card may include at least one of the following information: identification information of the bank card (e.g., card number of the bank card), identification information of the bank card holder (e.g., name information of the user), attribute information of the bank card (e.g., validity period information of the bank card, card issuing bank information, card type information (e.g., credit card, debit card)), security code of the bank card (e.g., CVV password), credit limit information of the bank card, and consumption information of the bank card (e.g., user inquiry history card payment information may be provided).

Alternatively, the privacy information and the verification information corresponding to different privacy information may be set by the user himself or set in the bank service platform to flexibly and variously provide the user with privacy content that may be hidden and displayed through verification. As well as providing users with diversified verification methods to facilitate and more safely implement the verification process. For example, the user may set a verification problem for displaying the card number information by himself. For example, if the user's mobile phone number is entered as the verification information, the verification is passed and the card number information is displayed on the display screen of the bank card. The above setting function may be set by the user to operate the operation keyboard on the card surface of the bank, or the bank card may be connected with the terminal device based on the card reader or wireless/wired network connection, and an application program is installed in the terminal device, which is used for setting and operating the privacy information to be hidden and the verification information corresponding to the hidden information. Therefore, the information resources and processing resources stored in the bank card can be saved, and a more convenient and efficient bank card privacy information setting function is provided for users by virtue of the processing capability of external terminal equipment and a friendly user interaction interface.

FIG. 3 is a schematic structural diagram of a bank card provided by an exemplary embodiment of the application. As shown in FIG. 3, the embodiment provides a bank card for improving the safety of the bank card. Specifically, the bank card includes:

an acquisition module 31 configured to acquire verification information of the bank card; and
wherein the display module 32 is configured to display the privacy information of the bank card on the display screen of the bank card when the verification information passes the verification.

In practical application, the bank card is integrated with a processing chip which has functions of reading and executing computer programs to execute related computer programs, thus implementing the method provided by the scheme. Alternatively, the processing chip may have a China Operating System (COS).

The bank card provided in this embodiment may be used to implement the method shown in FIG. 1, and the implementation principle is similar, and details are not described herein again.

According to the bank card provided by the embodiment, the verification information of the bank card is acquired; and if the verification information passes the verification, the privacy information of the bank card is displayed on the display screen of the bank card. According to the scheme, the privacy information of the bank card is displayed to the user based on verification, so that the privacy information of any user involved in the bank card can be protected, for example, the card number, the validity period, the security code and the like on the card surface are displayed on the card surface after the verification is passed, thereby ensuring the use safety of the bank card and avoiding user loss.

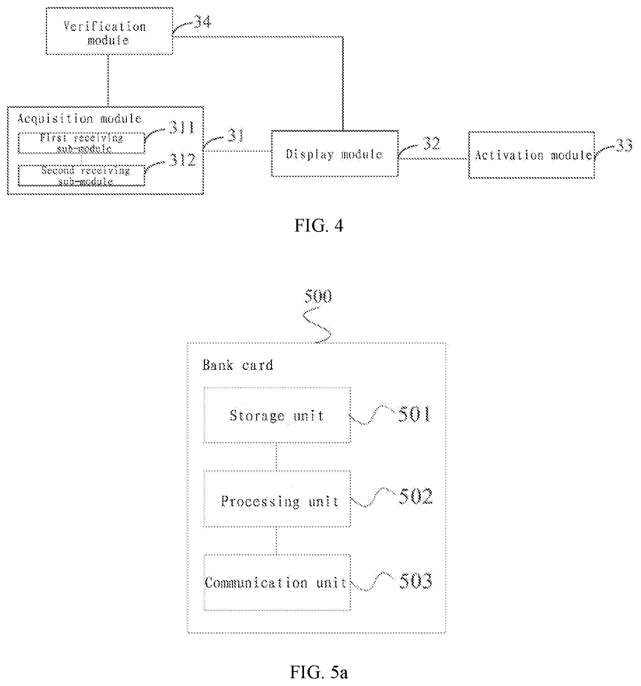

FIG. 4 is a schematic structural diagram of a bank card provided by another exemplary embodiment of the application. As shown in FIG. 4, in the basis of the above embodiment,

The acquisition module 31 includes:

a first receiving sub-module 311 configured to receive the verification information input by the user on the card surface of the bank.

Optionally, the acquisition module 31 further includes:

a second receiving sub-module 312 configured to receive the unlocking information input by the user on the card surface of the bank.

The unlocking information includes at least one of the following information:

fingerprint unlocking information, gesture unlocking information and password unlocking information.

Optionally, the second receiving sub-module 312 is specifically configured to receive the unlocking information input by the user in the unlocking identification area of the bank card.

The bank card further includes:

an activation module 33 configured to activate the verification operation function for the bank card when the unlocking information makes successful unlocking.

The display module 32 is further configured to display the verification operation function to the user in the display screen of the bank card.

Optionally, the privacy information of the bank card includes at least one of the following information:

identification information of bank card, identification information of bank card holders, attribute information of bank card, safety codes of bank card, credit limit information of bank card, and consumption information of bank card.

Optionally, it further includes:

a verification module 34 configured to verify an identity of the holder of the bank card according to the verification information; and
a display module 32 further configured to display the privacy information of the bank card on the display screen of the bank card when the verification module passes the verification.

It should be noted that the aforementioned embodiments may be implemented separately or in combination without conflict. Alternatively, the aforementioned modules may be set separately or integrated. For example, modules that perform the same or similar functions may be implemented by the same module. The module division of the aforementioned embodiments is only an example.

The bank card provided in this embodiment may be used to implement the method shown in FIG. 2, and the implementation principle is similar, and details are not described herein again.

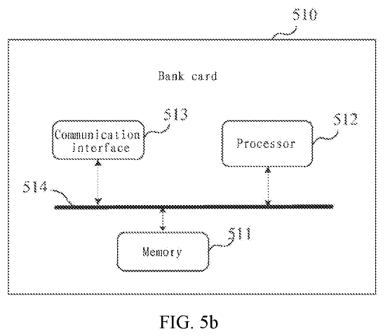

FIG. 5a is a schematic structural diagram of a bank card provided by an exemplary embodiment of the application. As shown in FIG. 5a, the bank card includes a processing unit 502 and a communication unit 503. The processing unit 502 is configured to control and manage actions of the bank card 500. For example, the processing unit 502 is configured to support the bank card 500 to perform steps 101-102 of FIG. 1. The processing unit 502 may also be configured to support the bank card 500 to perform steps 201-205 of FIG. 2 and/or other processes for the technology described herein. The communication unit 503 is used for communication between the bank card 500 and other network entities. The bank card 500 may further include a storage unit 501 for storing program codes and data of the bank card 500.

Herein, the processing unit 502 may be a processor or a controller, such as a CPU, a general-purpose processor, a Digital Signal Processor (DSP), an application—specific integrated circuit (ASIC), a Field Programmable Gate Array (FPGA), or other programmable logic devices, transistor logic devices, hardware components, or any combination thereof. These may implement or execute the various illustrative logical blocks, modules, and circuits described in connection with the disclosure. The processor may also be a combination that implements computing functions, such as a combination that includes one or more microprocessors, a combination of DSP and microprocessors, and the like. The communication unit 503 may be a communication interface, a transceiver, a transceiver circuit, and the like, where the communication interface is a collective name and may include one or more interfaces. The storage unit 501 may be a memory.

When the processing unit 502 is a processor, the communication unit 503 is a communication interface, and the storage unit 501 is a memory, the bank card referred to in this application may be the bank card 510 shown in FIG. 5b.

Referring to FIG. 5b, the bank card 510 includes a processor 512, a communication interface 513, and a memory 511. Optionally, the bank card 510 may further include a bus 514. Herein, the communication interface 513, the processor 512 and the memory 511 may be connected to each other through a bus 514. The bus 514 may be a Peripheral Component Interconnect (PCI) bus or an Extended Industry Standard Architecture (EISA) bus or the like. The bus 514 may be divided into an address bus, a data bus, a control bus, and the like. For ease of representation, only one thick line is used in FIG. 5b, but it does not mean that there is only one bus or one type of bus.

In addition, a program is stored in the memory 511 and is configured to be executed by the processor 512, the program including instructions for executing the method of any of the above embodiments.

The embodiment of the application also provides a bank card readable storage medium, wherein the bank card readable storage medium stores a program that causes a server to execute the interaction method based on user emotion provided in any of the embodiments. Herein, the above-mentioned readable storage medium may be implemented by any type of volatile or nonvolatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

Those skilled in the art may clearly understand that for convenience and brevity of description, the specific working process of the above-described financial card may refer to the corresponding process in the previous method embodiment.

One of ordinary skill in the art may understand that all or part of the steps for implementing the above-mentioned method embodiments may be completed by hardware related to program instructions. The aforementioned program may be stored in a computer readable storage medium. When the program is executed, steps including the above method embodiments are executed; however, the aforementioned storage media include ROM, RAM, magnetic disk or optical disk and other media capable of storing program codes.

Finally, it should be noted that the above-mentioned embodiments are only used to illustrate the technical scheme of the application, and are not limited thereto; although the application has been described in detail with reference to the above-mentioned embodiments, it should be understood by those of ordinary skill in the art that it may still modify the technical scheme described in the above-mentioned embodiments or replace some or all of its technical features equally; however, these modifications or substitutions do not cause the essence of the corresponding technical solutions to depart from the scope of the technical solutions of the embodiments of this application.

1.-14. (canceled)

15. A bank card privacy information hiding method, comprising:
acquiring verification information of a bank card; and
if the verification information passes a verification, displaying privacy information of the bank card on a display screen of the bank card.

16. The method of claim 15, wherein the acquiring the verification information of the bank card comprises:
receiving the verification information input by a user on a surface of the bank card.

17. The method of claim 16, wherein before the acquiring the verification information of the bank card, the method further comprises:
receiving unlocking information input by the user on the surface of the bank card;
wherein the unlocking information includes at least one of the following information:
fingerprint unlocking information, gesture unlocking information and password unlocking information.

18. The method of claim 17, further comprising:
receiving the unlocking information input by the user in an unlocking identification area of the bank card; and
if the unlocking information makes successful unlocking, activating a verification operation function for the bank card, and displaying the verification operation function to the user in the display screen of the bank card.

19. The method of claim 15, wherein the privacy information of the bank card comprises at least one of the following information:
identification information of the bank card, identification information of the bank card holder, attribute information of the bank card, a security code of the bank card, credit limit information of the bank card, and consumption information of the bank card.

20. The method of claim 15, wherein after acquiring the verification information of the bank card, the method further comprises:
verifying an identity of a holder of the bank card according to the verification information, and if the verification is passed, displaying the privacy information of the bank card on the display screen of the bank card.

21. A bank card comprising:
an acquisition module configured to acquire verification information of the bank card; and
a display module configured to display privacy information of the bank card on a display screen of the bank card when the verification information passes a verification.

22. The bank card of claim 21, wherein the acquisition module comprises:
a first receiving sub-module configured to receive the verification information input by a user on a surface of the bank card.

23. The bank card of claim 22, wherein the acquisition module further comprises:
a second receiving sub-module configured to receive unlocking information input by the user on the surface of the bank card;
wherein the unlocking information includes at least one of the following information:
fingerprint unlocking information, gesture unlocking information and password unlocking information.

24. The bank card of claim 23, wherein, the second receiving sub-module is specifically configured to receive the unlocking information input by the user in an unlocking identification area of the bank card;
the bank card further comprises:
an activation module, configured to activate a verification operation function for the bank card when the unlocking information makes successful unlocking;
wherein the display module is further configured to display the verification operation function to the user in the display screen of the bank card.

25. The bank card of claim 21, wherein the privacy information of the bank card comprises at least one of the following information:
identification information of the bank card, identification information of the bank card holder, attribute information of the bank card, a security code of the bank card, credit limit information of the bank card, and consumption information of the bank card.

26. The bank card of claim 21, further comprising:
a verification module configured to verify an identity of the holder of the bank card according to the verification information;
wherein the display module is further configured to display the privacy information of the bank card on the display screen of the bank card when the verification module passes the verification.

27. A bank card comprising:
a processor and a memory;
the memory storing a computer program; the processor executing the computer program stored in the memory to perform a method of claim 15.

28. A computer readable storage medium having stored therein a computer program that, when executed by a processor, implements a method of claim 15.
